(19) United States
(12) Patent Application Publication
(10) Pub. No.: US 2024/0008475 A1
(43) Pub. Date: Jan. 11, 2024

(54) ORGAN PROCUREMENT DEVICES, SYSTEMS, AND METHODS

(71) Applicant: Nicholas J. Shea, Harding Township, NJ (US)

(72) Inventor: Nicholas J. Shea, Harding Township, NJ (US)

(21) Appl. No.: 18/220,064

(22) Filed: Jul. 10, 2023

Related U.S. Application Data
(60) Provisional application No. 63/388,230, filed on Jul. 11, 2022.

(51) Int. Cl. A01N 1/02

(52) U.S. Cl. CPC A01N 1/0247; A01N 1/0252

(57) ABSTRACT

An organ procurement perfusion pump system can include a portable enclosure, a fluid line, a pump disposed within the enclosure configured to cause flow the line, one or more sensors disposed in functional communication with the fluid line, and a thermal control cavity within the enclosure configured to contain one or more perfusate containers which connect to the fluid line to regulate the temperature of the perfusate. The system can further include a control module operatively connected to the pump and the one or more sensors, and configured to control the pump.

### CROSS-REFERENCE TO RELATED APPLICATIONS

This application claims priority to and the benefit of U.S. Provisional Application No. 63/388,230, filed Jul. 11, 2022, the entire contents of which are herein incorporated by reference in their entirety.

### FIELD

This disclosure relates to organ procurement.

### BACKGROUND

In traditional organ procurement (e.g., heart procurement from a donor), there is no precise controlled delivery of preservation solution to the organ during the organ procurement procedure. There are no suitable systems for such procurement procedures either, which are usually performed by mobile staff.

Conventional methods and systems have generally been considered satisfactory for their intended purpose. However, there is still a need in the art for improvements. The present disclosure provides a solution for this need.

### SUMMARY

An organ procurement perfusion pump system can include a portable enclosure, a fluid line, a pump disposed within the enclosure configured to cause flow the line, one or more sensors disposed in functional communication with the fluid line, and a thermal control cavity within the enclosure configured to contain one or more perfusate containers which connect to the fluid line to regulate the temperature of the perfusate. The system can further include a control module operatively connected to the pump and the one or more sensors, and configured to control the pump.

In certain embodiments, the system can include a wireless communication module (e.g., Bluetooth, wifi, radio, etc.) connected to control module to allow communication with a mobile device. For example, the control module can be configured to output data (e.g., via the wireless communication module) to a mobile device, and/or to receive commands from the mobile device to control the pump.

The control module can be configured to automatically control the pump as a function of output from the one or more sensors to maintain perfusate parameters within one or more thresholds. For example, the control module can be configured to control the pump as a function of a set flow parameter and/or pressure parameter (e.g., to achieve and/or maintain the perfusate parameter within the one or more thresholds).

In certain embodiments, the one or more sensors can include a flow meter configured to read a flow in the fluid line, a pressure sensor configured to read a pressure in the fluid line, and a temperature sensor configured to read temperature of the perfusate in the fluid line. In certain embodiments, the system can include an air filter configured to remove air from the fluid line upstream of the one or more fluid sensors. The one or more fluid sensors can be downstream of the pump, for example (e.g., within the portable enclosure).

In certain embodiments, the thermal control cavity can be configured to contain and/or insulate passive temperature regulation media. In certain embodiments, the system can include an active cooling system in thermal communication with the thermal control cavity configured to regulate the temperature of the perfusate.

In certain embodiments, the system can include an energy supply configured to power the active cooling system. The control module can be configured to control the active cooling system to control a temperature of the perfusate based on one or more temperature signals.

In certain embodiments, the system can include a manifold upstream of the pump configured to connect to a plurality of perfusate containers. For example, the manifold can be located within a thermal control cavity and configured to receive a plurality of perfusate containers (e.g., intravenous bags).

A method can include actively controlling a pressure and/or flow of perfusate to an organ of a donor during organ procurement. The method can further include controlling temperature of the perfusate during organ procurement. In certain embodiments, actively controlling the pressure and/or flow can include using a portable perfusate pump system. In certain embodiments, actively controlling the pressure and/or flow can include using a mobile device connected to the portable perfusate pump system.

In accordance with at least one aspect of this disclosure, a non-transitory computer readable medium comprising computer executable instructions configured to cause a computer to perform a method. The method can include actively controlling a pressure and/or flow of perfusate to an organ of a donor during organ procurement as a function of feedback from one or more pressure sensors and/or flow sensors. The method can include controlling temperature of the perfusate during organ procurement as a function of temperature feedback from one or more temperature sensors. In certain embodiments, actively controlling can include controlling a portable perfusate pump system. In certain embodiments, actively controlling can include receiving inputs from a mobile device connected to the portable perfusate pump system to control the portable perfusate pump system.

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic diagram of an embodiment of a system in accordance with this disclosure, showing a portable perfusion pump device and associated user interface on a mobile device.

FIG. 2 is a schematic diagram of an embodiment of a system in accordance with this disclosure, showing a portable perfusion pump device and associated user interface on a mobile device.

FIG. 3 is a schematic diagram of an embodiment of a graphical user interface (GUI) in accordance with this disclosure.

### DETAILED DESCRIPTION

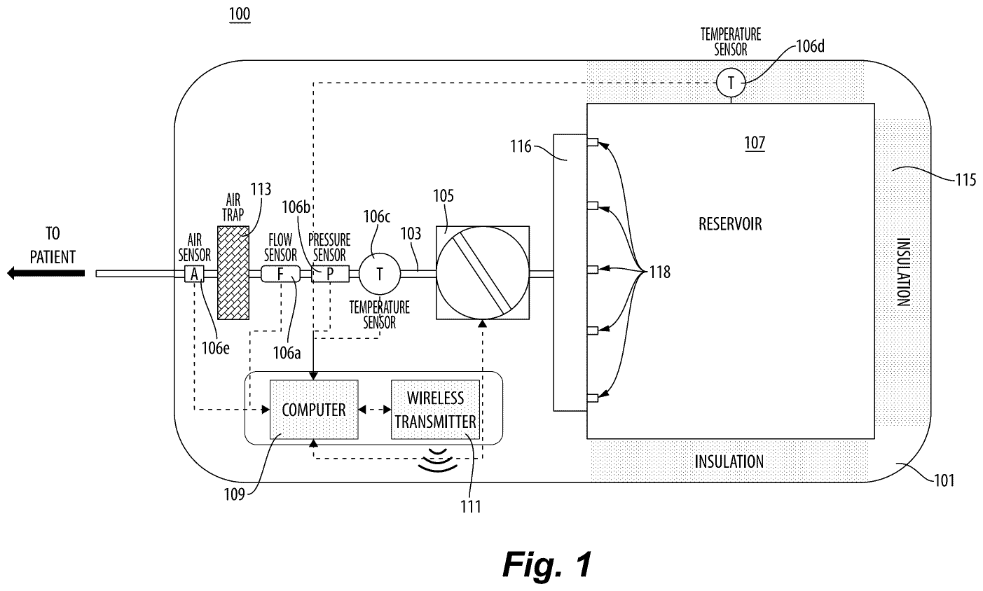

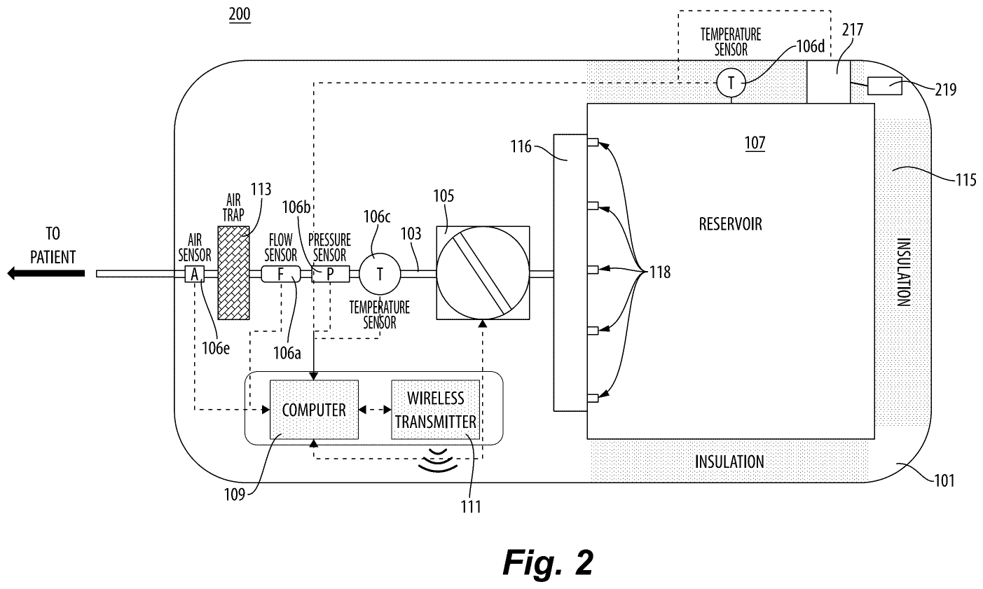

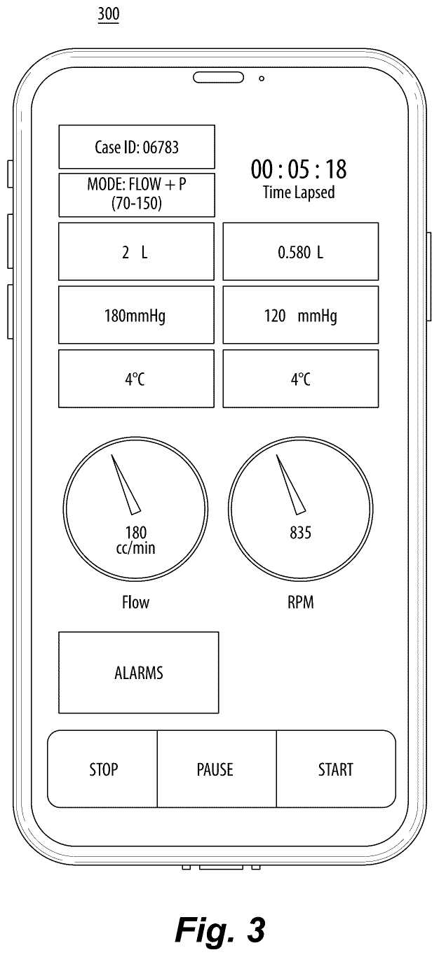

Reference will now be made to the drawings wherein like reference numerals identify similar structural features or aspects of the subject disclosure. For purposes of explanation and illustration, and not limitation, an illustrative view of an embodiment of a system in accordance with the disclosure is shown in FIG. 1 and is designated generally by reference character 100. Other embodiments and/or aspects of the disclosure are shown in FIGS. 2 and 3. Certain embodiments described herein can be used to provide a consistent, reliable, measurable delivery of preservation solution during organ procurement with easily measured and controlled variables related to solution and solution delivery. Such devices, systems and methods can improve outcomes and reduce unexplained failures in organ recipients.

Referring to FIG. 1, an organ procurement perfusion pump system 100 can include a portable enclosure 101, a fluid line 103, and a pump 105 disposed within the enclosure configured to cause flow the line 103. For example, the pump 105 can be in fluid communication with the fluid line 103 (e.g., axial flow pump, centrifugal pump, peristaltic pump) and/or can be in exterior communication to deform the line 105 to cause flow (e.g., using a roller pump, exterior peristaltic pump). The system 100 can include one or more sensors 106a, b, c, d, e disposed in functional communication with the fluid line 103.

The system 100 can include a thermal control cavity 107 (e.g., a reservoir or other suitable compartment) within the enclosure 101 configured to contain one or more perfusate containers (not shown) which connect to the fluid line 103 to regulate the temperature of the perfusate. The system 100 can further include a control module 109 operatively connected to the pump 105 and the one or more sensors 106a, b, c, d, e to receive sensor signals therefrom. The control module 109 can be configured to control the pump 105, for example.

In certain embodiments, the system 100 can include a wireless communication module (e.g., Bluetooth, wifi, radio, etc.) 111 connected to control module 109 to allow communication with a mobile device (e.g., a cell phone or tablet or other portable computing device). For example, the control module 109 can be configured to output data (e.g., via the wireless communication module 111) to a mobile device, and/or to receive commands from the mobile device to control the pump 105.

In certain embodiments, the control module 109 can be configured to automatically control the pump 105 as a function of output from the one or more sensors 106a, b, c, d, e to maintain perfusate parameters within one or more thresholds (e.g., a high and/or low threshold). For example, the control module 109 can be configured to control the pump 105 as a function of a set flow parameter and/or pressure parameter (e.g., to achieve and/or maintain the perfusate parameter within and/or below the one or more thresholds). The control module 109 can be configured to alert the user additionally or alternatively (e.g., of one or more exceeded thresholds or other suitable conditions, e.g., flow rate, temperature, pressure, etc.).

In certain embodiments, the one or more sensors 106a, b, c, d, e can include a flow meter 106a configured to read a flow in the fluid line 103. The one or more sensors 106a, b, c, d, e can include a pressure sensor 106b configured to read a pressure in the fluid line 103. In certain embodiments, the one or more sensors 106a, b, c, d, e can include a temperature sensor 106c configured to read temperature of the perfusate in the fluid line 103. In certain embodiments, the system 100 can include an air filter 113 configured to remove air from the fluid line 103 upstream of the one or more fluid sensors 106a, b, c, d, e. In certain embodiments, the one or more sensors 106a, b, c, d, e can include a thermal control cavity temperature sensor 106d configured to sense a temperature of the thermal control cavity 107. In certain embodiments, the one or more sensors 106a, b, c, d, e can include an air sensor 106e configured to sense the presence and/or content of air in the fluid line 103. The one or more fluid sensors 106a, b, c, e can be downstream of the pump 105, for example (e.g., within the portable enclosure).

In certain embodiments, the thermal control cavity 107 can be configured to contain and/or insulate passive temperature regulation media (e.g., dry ice, water ice, or other suitable media). For example, the thermal control cavity 107 can be at least partially encased by insulation 115 within the enclosure 101.

In certain embodiments, the system 100 can include a manifold 116 upstream of the pump 105 configured to connect to a plurality of perfusate containers. For example, the manifold 116 can be located within a thermal control cavity 107 and configured to receive (and fluidly communicate with) a plurality of perfusate containers (e.g., standard intravenous (IV) bags), e.g., at one or more attachments 118 (e.g., standard IV bag ports).

In certain embodiments, referring to FIG. 2, the system 200 can include an active cooling system 217 in thermal communication with the thermal control cavity 107. The active cooling system 217 can be configured to regulate the temperature of the perfusate within the thermal control cavity 107. For example, the active cooling system 217 can include a refrigeration system.

In certain embodiments, the system 200 can include an energy supply 219 configured to power the active cooling system 217. In certain embodiments, the energy supply 219 can be configured to additionally or alternatively power any one or any combination of the pump, computer, and sensors of the device. The control module 109 can be configured to control the active cooling system 217 to control a temperature of the perfusate based on one or more temperature signals, e.g., from the temperature sensor 106d. The control module can be configured to output data relating to the active cooling system to the mobile device, and/or to receive commands from the mobile device to control the active cooling system.

Referring to FIG. 3, an embodiment of a graphical user interface (GUI) 300 is shown for interfacing with and/or controlling the system of claim 1. For example, embodiments can include a software application (e.g., for a mobile device, or for hardware associated with the perfusion device housing) having a graphical user interface (GUI) with controls. For example, for an initial loading, the GUI can include an input for a unique identifier (for linking to a certain organ or procedure). The GUI can include an interface for choosing flow regulated mode or pressure regulated mode. If flow regulated is selected, the GUI can present an option to select pressure limited and provide upper pressure limits, or select not pressure limited mode, and then a user input to provide a flow rate selection after either. If pressure regulated is selected, the GUI can be configured to have a user input to provide a target pressure. The GUI can be configured to allow a user to set total volume to instill. The GUI can be configured to prompt load desired volume+500 ml to 1 L extra (e.g., for initial deairing and reserve). Embodiments of a GUI can be configured to allow setting of alarm parameters, default parameters, or any other suitable parameter in relation to signals from the various sensors 106a, b, c, d, e. In a deairing mode, low flow mode, or therapy mode, embodiments can provide controlled instillation.

Certain embodiments can be configured to measure line pressure, back pressure, arterial pressure at infusion site (e.g., calculated if using standard tubing length/diameter), flow, duration of perfusion, volume of perfusion, solution temperature in reservoir, solution temperature at outflow, and pump RPM. For example, the flow sensor 106a and/or pressure sensor 106b can be configured to directly measure or deduce any suitable pressure parameter (e.g., as disclosed above).

Embodiments can include controls (e.g., via the GUI of a software application) that can include active temperature maintenance, e.g., if an active cooling system is employed. In certain embodiments, an ice reservoir may be utilized as opposed to an active cooling system or other suitable thermal management (e.g., heat or cold) system. Controls can include administration of solution with flow control with and/or without pressure limiting, pressure control, and/or volume of administration. In certain embodiments, the controls can include a deairing mode (e.g., an initial low flow phase to flush the line of air).

Embodiments can include indicators and/or alarms (e.g., physical indicators on the enclosure and/or in app notification) for one or more of high/low pressure, high/low temp, air, pump speed, low flow, or other suitable parameters. Embodiments can include a control module (e.g., an internal computer) configured to control and/or manage the pump in response to one or more suitable parameters (e.g., described above).

Embodiments of a GUI can include a dashboard. For example, in a therapy mode, the dashboard can include one or more (e.g., all or any combination of) unique identifier for the case, pause/start/stop controls, what mode is selected (flow regulated vs. pressure regulated) and parameters, current alarm parameters where alarms will be set off/flash, continuous flow meter, continuous line pressure, continuous arterial bed (infusion site) pressure (calculated), line temperature, reservoir temperature, target volume for infusion, total volume infused, time elapsed, and/or pump RPM. Any other suitable parameters are contemplated herein that are salient to organ procurement, for example.

Embodiments of a system and/or software application can be configured to record and store data across multiple organ procurement events for tracking and research. Embodiments can be applied to any suitable organ procurement, e.g., multiple transplantable organs such as heart, lung, liver, pancreas, intestine, kidneys, and liver.

In accordance with at least one aspect of this disclosure, a method can include actively controlling a pressure and/or flow of perfusate to an organ of a donor during organ procurement. The method can further include controlling temperature of the perfusate during organ procurement. In certain embodiments, actively controlling the pressure and/or flow can include using a portable perfusate pump system. In certain embodiments, actively controlling the pressure and/or flow can include using a mobile device connected to the portable perfusate pump system.

Embodiments of a system can include a portable enclosure that can be configured automate preservation solution (perfusate) delivery while measuring, controlling, and recording key variables, adding a higher degree of data-driven control and eliminating variability and error across procurements, users, and organs. For example, the portable enclosure can be the size and/or shape of a briefcase and have one or more handles for carrying. In certain embodiments, the portable enclosure can be the size and/or shape of a cooler and have one or more handles and/or rolling wheels for pulling the enclosure. Embodiments can be portable, lightweight, user friendly, easy to use, require little technical skill, require short training and uptake time, and allow replicable and reliable use across users and contexts.

Embodiments can provide fully consistent reliable function. Embodiments can be made to be single use which can eliminates costly maintenance and storage. Certain embodiments can include no display or other unnecessary electronics to reduce size, weight, and cost such that each device can be less wastefully disposed of. For example, certain embodiments can be strictly controlled and monitored via a software application on a mobile device. Embodiments can be made of less expensive single use materials (e.g., all plastic components for pump parts, etc.). Embodiments can include a single use battery, disposable batteries, or a rechargeable battery for powering the control module and/or wireless communication systems. Embodiments may include no battery and strictly be plug in powered. Embodiments may include a charge/power port and can be configured to be powered via a portable battery. Embodiments can include a data port for connecting via wire to a mobile device, for example.

Embodiments can integrate into the existing clinical paradigm, utilize existing solutions and methods, can work with existing solution storage forms (e.g., IV bags), and can be configured to work with existing tubing and cannulae. Embodiments can use variables commonly used in clinical practice, can be inexpensive to manufacture, require low or no upkeep, have minimal moving parts, and minimal electronics (e.g., data and controls can be accessed via a software application, e.g., on a mobile device).

Embodiments can include a wireless transmitter (e.g., a bluetooth transmitter) connected and/or in communication with the control module. The wireless transmitter can be configured to allow communication with a mobile device or other suitable device, e.g., via a software application to allow the mobile device to receive information from the control module and/or provide control inputs to the control module. For example, embodiment can be configured to Bluetooth connect to a mobile app where parameters can be set. Air handling can also be in line.

Embodiments can include any suitable computer hardware and/or software module(s) to perform any suitable function (e.g., as disclosed herein).

As will be appreciated by those skilled in the art, aspects of the present disclosure may be embodied as a system, method or computer program product. Accordingly, aspects of this disclosure may take the form of an entirely hardware embodiment, an entirely software embodiment (including firmware, resident software, micro-code, etc.), or an embodiment combining software and hardware aspects, all possibilities of which can be referred to herein as a “circuit,” “module,” or “system.” A “circuit,” “module,” or “system” can include one or more portions of one or more separate physical hardware and/or software components that can together perform the disclosed function of the “circuit,” “module,” or “system”, or a “circuit,” “module,” or “system” can be a single self-contained unit (e.g., of hardware and/or software). Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of this disclosure may be described above with reference to flowchart illustrations and/or block diagrams of methods, apparatus (systems) and computer program products according to embodiments of this disclosure. It will be understood that each block of any flowchart illustrations and/or block diagrams, and combinations of blocks in any flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in any flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

What is claimed is:

1. An organ procurement perfusion pump system, comprising:
a portable enclosure;
a fluid line;
a pump disposed within the enclosure configured to cause flow in the line;
one or more sensors disposed in functional communication with the fluid line;
a thermal control cavity within the enclosure configured to contain one or more perfusate containers which connect to the fluid line to regulate the temperature of the perfusate; and
a control module operatively connected to the pump and the one or more sensors, and configured to control the pump.

2. The system of claim 1, further comprising a wireless communication module connected to control module to allow communication with a mobile device.

3. The system of claim 1, wherein the control module is configured to output data to a mobile device, and/or to receive commands from the mobile device to control the pump.

4. The system of claim 3, wherein the control module is configured to automatically control the pump as a function of output from the one or more sensors to maintain perfusate parameters within one or more thresholds.

5. The system of claim 4, wherein the thermal control cavity is configured to contain and/or insulate passive temperature regulation media.

6. The system of claim 4, wherein the system includes an active cooling system in thermal communication with the thermal control cavity configured to regulate the temperature of the perfusate.

7. The system of claim 6, further comprising an energy supply configured to power the active cooling system.

8. The system of claim 7, wherein the control module is configured to control the active cooling system to control a temperature of the perfusate based on one or more temperature signals.

9. The system of claim 1, wherein the one or more sensors include a flow meter configured to read a flow in the fluid line, a pressure sensor configured to read a pressure in the fluid line, and a temperature sensor configured to read temperature of the perfusate in the fluid line.

10. The system of claim 9, further comprising an air filter configured to remove air from the fluid line upstream of the one or more fluid sensors.

11. The system of claim 10, wherein the one or more fluid sensors are downstream of the pump.

12. The system of claim 11, further comprising a manifold upstream of the pump configured to connect to a plurality of perfusate containers.

13. A method, comprising:
actively controlling a pressure and/or flow of perfusate to an organ of a donor during organ procurement.

14. The method of claim 13, further comprising controlling temperature of the perfusate during organ procurement.

15. The method of claim 13, wherein actively controlling includes using a portable perfusate pump system.

16. The method of claim 15, wherein actively controlling includes using a mobile device connected to the portable perfusate pump system.

17. A non-transitory computer readable medium comprising computer executable instructions configured to cause a computer to perform a method, the method comprising:
actively controlling a pressure and/or flow of perfusate to an organ of a donor during organ procurement as a function of feedback from one or more pressure sensors and/or flow sensors.

18. The non-transitory computer readable medium of claim 17, wherein the method further comprises controlling temperature of the perfusate during organ procurement as a function of temperature feedback from one or more temperature sensors.

19. The non-transitory computer readable of claim 18, wherein actively controlling includes controlling a portable perfusate pump system.

20. The non-transitory computer readable of claim 19, wherein actively controlling includes receiving inputs from a mobile device connected to the portable perfusate pump system to control the portable perfusate pump system.
